(19) United States
(12) Patent Application Publication
(10) Pub. No.: US 2004/0078544 A1
(43) Pub. Date: Apr. 22, 2004

(54) Memory address remapping method

(75) Inventors: Ming-Hsien Lee, Hsinchu (TW); Te-Lin Ping, Taoyuan (TW); Su-Min Liu, Hsinchu (TW); Tsan-Hwi Chen, Hsinchu (TW)

Correspondence Address: SUGHRUE MION, PLLC, 2100 PENNSYLVANIA AVENUE, N.W., SUITE 800, WASHINGTON, DC, 20037, US

(73) Assignee: SILICON INTEGRATED SYSTEMS CORPORATION

(21) Appl. No.: 10/272,918

(22) Filed: Oct. 18, 2002

(51) Int. Cl. G06F 12/00

(52) U.S. Cl. 711/202

(57) ABSTRACT

A memory address remapping method is disclosed. The memory address remapping method comprises: providing a cache-related address having a tag, an associative tag, a set index and a block offset; providing a linear operator; performing a linear calculation with a first linear operator input and a second linear operator input to obtain a first output, wherein the first linear operator input is several bits picked from the set index of the cache-related address according to a quantity and a corresponding location of a plurality of bits in the location address of a memory address, such as DDR memory-related address, Rambus memory-related address, etc., and the second linear operator input is several bits picked from the tag and the associative tag of the cache-related address according to the quantity of the plurality of bits in the location address; and performing a replacing step comprising: choosing several key transition bits from the tag to replace several first-output bits in the first output for obtaining a second output, wherein the several first-output bits in the first output are more stable than other first-output bits in the first output, and the several key transition bits have a characteristic of more frequent changing than other bits that are higher order than the several key transition bits in the tag; and assigning the second output to be a target location address of a target memory address of a plurality of memory addresses, wherein data is saved from the cache to the target location in correspondence with the target memory address. Therefore, the data in cache can be distributed to page of different banks in memory module, so that the page hit rate and bandwidth utilization are increased.

### FIELD OF THE INVENTION

The present invention relates to a memory address remapping method, and more particularly relates to a memory address remapping method utilized in various memory system for enhancing the accessing efficiency of memory.

### BACKGROUND OF THE INVENTION

According to a basic computer system, a north bridge is connected with a processor through a host bus, and is connected with a memory module through a memory bus, and is connected with other devices, such as an AGP display module, a south bridge, etc., through different buses. Moreover, there are various other devices, such as PCI devices, connected with the south bridge. If a read cycle or write cycle is issued to the memory module by the processor or other devices, it is necessary to the read cycle or write cycle through the memory bus.

On the other hand, a memory bank (hereinafter bank) is a logical unit of the memory module in the computer system, and the size of memory bank is determined by the processor. For example, a 32-bit processor can calls for memory banks to provide 32 bits of information one time. One page of a bank represents the number of bits that can be accessed in a memory module from a row address, and the page size is dependent on the number of column address. Moreover, each bank has a row-buffer holding a page of data, and conventionally, only one page in a bank can be opened one time.

While in one memory access, three probabilities are likely to occur, which will be described as follows. One memory access usually consists of an activation step, a command step (such as a command read, a command write, etc), and a precharge step. The activation step is used to open the desired bank and page of memory, and the command read/write step is used to enable a memory controller to read/write data from/to the memory module, and the precharge step is issued to close the page of specific bank opened by the activation step.

Herein the three probabilities mentioned above are described, and comprises:

I. Page-hit: the page of current memory access is identical to that of previous memory access in all banks, wherein only the precharge and row activation steps are needed to initiate the first access, and the subsequent accesses only require the column activation step, so that these memory accesses with Page-hit can be well and fully pipelined and the memory access latency is lowered because of the memory localization and the exploration of entire bandwidth.

II. Bank-miss and Page-miss: the page of current memory access is different from all the opening pages, which means that the pages have been activated by the activation step in all banks, and the bank in which the page of current memory access is located, is different from the one accessed previously. Since the memory accesses with Bank-miss and Page-miss can be done in parallel, so that the corresponding operations can also be well pipelined.

III. Bank-hit and Page-miss: the page of current memory access is different from all the opening pages in all banks, but the page of current memory access belongs to the same bank as the page of previous memory access. The memory accesses with Bank-hit and Page-miss cause the row-buffer conflicts, and moreover, the precharge step and the row activation are needed to initiate every memory access. Therefore, these memory accesses with Bank-hit and Page-miss cannot be well pipelined, so that more latency is induced in comparison with those with Page-hit, or those with Bank-miss and Page-miss, and the memory bandwidth is just utilized partially.

Please referring to FIG. 1 and FIG. 2, FIG. 1 is a diagram showing the memory accesses with Bank-miss and Page-miss, and FIG. 2 is a timing relationship between the current memory access and subsequent memory access with Bank-miss and Page-miss according to FIG. 1. For example, the page of current memory access is page A 10 in the Bank A, and afterwards, the page of subsequent memory access is page B 20 in the bank B. Since there is the Bank-miss and Page-miss feature between the current memory access and subsequent memory access, a well pipelined operation can be executed on the current memory access and the subsequent memory access as shown in FIG. 2, wherein the activation step 60 of subsequent memory access 40 can be started after the activation step 50 of current memory access 30 is finished, and the command write 70 of current memory access 30 and the command read 80 of subsequent memory access 40 are executed almost simultaneously in one period, and the current memory access 30 and the subsequent memory access 40 are in the precharged step 90 or closed respectively.

On the other hand, the memory accesses with Page-hit can be well pipelined similarly, due to the same page accessed by the current memory access and the subsequent memory access.

However, since only one page in a bank can be opened one time, if the current memory request is a read cycle or a write cycle to page A in a bank, and the subsequent memory request is a read cycle or a write cycle to page B in the same bank, the page A has to be closed or precharged before the subsequent memory request is started.

Please referring to FIG. 3 and FIG. 4, FIG. 3 is a diagram showing the memory accesses with Bank-hit and Page-miss, and FIG. 4 is a time relationship between the current memory access and subsequent memory access with Bank-hit and Page-miss according to FIG. 3. As shown in FIG. 3, the page of current memory access is page C 105 in the Bank E, and afterwards, the page of subsequent memory access is page D 110 in the same bank E. Since the current memory access 115 and the subsequent memory access 120 are on two different pages in the same bank, a plurality of steps (such as an activation step 125, a command read step 130, and a precharge step 135) in the current memory access 115 have been first completed in sequence. Thereafter, a plurality of steps (such as an activation step 140, a command read step 145, and a precharge step 150) in the subsequent memory access 120 are executed in sequence. Therefore, the row-buffer conflict is increased and the bandwidth utilization is decreased, and the higher latency in memory access is induced.

In a conventional computer architecture, at least one cache memory (hereinafter cache) is designed and implemented to save data that is frequently utilized by computer system, in order to enhance the hit rate in execution of command reads or command writes issued from processor or other devices, and hence the access between cache and processor or other devices is faster than that between memory module and processor or other devices.

However, the storage volume of cache is finite. Therefore, when the cache is full of data but other data need to save into the cache, at least one data in the full cache has to be transported and saved into a memory module, such as DDR memory module, Rambus memory module, etc., depending on which memory system is utilized. When the at least one data in the cache is transported into the memory module, a target memory address, which is one of the plurality of memory addresses in the memory module, and indicates the target location that the at least one data transported from the cache into, must be resolved and obtained first. Thus, a conversion process is performed to the cache-related address, to which the least one data in the cache corresponds, so as to obtain the target memory address, wherein the target memory address and the cache-related address have the same content (hereinafter address-content), which means each of the total bits included in the cache-related address is the same as that included in the target memory address, but the definition and expression of the cache-related address to the address-content are different from those of the target memory address to the address-content. Briefly, no matter which memory system, such as DDR memory system, Rambus memory system, etc., is utilized, the address-content of the cache-related address and the address-content of the target memory address are the same when data is transported and saved from the cache into the memory module.

Please referring to FIG. 5, FIG. 5 is a diagram showing the definition of a conventional cache-related address in a cache. As shown in FIG. 5, according to the definition of a conventional cache-related address 170, the address-content is defined and partitioned into several parts of the conventional cache-related address 170. The several parts are a block address 175 and a block offset 180 respectively, wherein the block address 175 comprises a tag 185 and a set index 190.

Please referring to FIG. 6, FIG. 6 is a diagram showing the definition of a conventional DDR memory-related address in a DDR memory module. As shown in FIG. 6, according to the definition of a conventional DDR memory-related address 200, the address-content is defined and partitioned into several parts of the conventional DDR memory-related address 200. The several parts are a page index 205 and a page offset 210 respectively, wherein the page index 205 consists of a high page index 215, a DIMM address 220, a side address 225 and a bank index 230. With regard to the definitions and operations of high page index 215, DIMM address 220, side address 225 and bank index 230, the detailed description are omitted herein, since those issues are well understood by those who skilled in the art.

Please referring to FIG. 7, FIG. 7 is a diagram showing the definition of a conventional Rambus memory-related address. As shown in FIG. 8, according to the definition of a conventional Rambus memory-related address 250, the address-content is defined and partitioned into several parts of the conventional Rambus memory-related address 250. The several parts are a page index 255 and a page offset 260 respectively, wherein the page index 255 consists of a row address 265, a bank address 270 and a device address 275, and the page offset 260 consists of a column 280, a channel 285 and an offset 290. About the definitions and operations of row address 265, bank address 270, device address 275, column 280, channel 285 and offset 290, the detailed description are omitted herein, since those are well understood by a person skilled in the art.

On the other hand, since there is at least one set in a cache and the at least one set has several different tags located thereon, according to different designs, therefore, the set indices among several cache-related addresses may be the same, but each of the tags of cache-related addresses has to be different from each other, so that data stored in each cache is corresponded to an unitary cache-related address.

However, there is a disadvantage when the data is transported and saved from cache to memory module by utilizing the conventional page interleaving method. For example, please referring to FIG. 8, FIG. 8 is a diagram showing the relationship between the conventional cache-related address and the conventional DDR memory-related address according to FIG. 5 and FIG. 6. By utilizing the conventional page interleaving method, if a DDR memory system is utilized, at least one data is transported from cache into a target location in DDR memory module according to the conventional target DIMM address, the conventional target side address and the conventional target bank index of a conventional target DDR memory-related address, wherein a plurality of corresponding bits in the set index 190 of the cache-related address 170 are re-defined to be the plurality of bits in the conventional target DIMM address, the conventional target side address and the conventional target bank index, and the conventional target DIMM address, the conventional target side address and the conventional target bank index indicate the target location that the at least one data saved into.

If the set index of data A, which is transported and saved from cache to the DDR memory module currently, is identical to the one of data B, which is transported and saved from cache to the DDR memory module subsequently, the data A and the data B may be distributed to a same bank but on different pages of the DDR memory module by utilizing the conventional page interleaving method. Thus, according to the aforementioned description about Bank-hit and Page-miss, row-buffer conflicts and longer latency are caused with respect to all three probabilities while the data A and data B are accessed. Hence, the row-buffer conflict is increased and the bandwidth utilization is decreased.

For another example, please referring to FIG. 9, FIG. 9 is a diagram showing the relationship between the conventional cache-related address and the conventional Rambus memory-related address according to FIG. 5 and FIG. 7. By utilizing the conventional page interleaving method, if a Rambus memory system is utilized, at least one data is transported from cache into a target location in Rambus memory module according to the conventional target bank address and the conventional target device address of a conventional target Rambus memory-related address, wherein a plurality of corresponding bits of the set index 190 of the cache-related address 170 are re-defined to be the plurality of bits in the conventional target bank address and the conventional target device address, and the conventional target bank address and the conventional target device address indicate the target location that the at least one data saved into.

Similarly, if the set index of data A, which is transported and saved from cache to the Rambus memory module currently, is identical to the one of data B, which is transported and saved from cache to the Rambus memory module subsequently, the data A and the data B may be distributed to a same bank but on different pages of the Rambus memory module by utilizing the conventional page interleaving method. Thus, according to the aforementioned description about Bank-hit and Page-miss, row-buffer conflicts and longer latency are caused.

### SUMMARY OF THE INVENTION

In view of the background of the invention described above, there are three probabilities of one memory access: Page-hit, Bank-miss and Page-miss, and Bank-hit and Page-miss. Since the occurrence of Bank-hit and Page-miss for memory access decreases the bandwidth utilization, and moreover, the issues of how to follow the progress of computer architecture, and how to fully utilize the available concurrency among multiple banks, and to exploit the localization of data available in the row-buffer of each bank have become critical for improving the computer system performance, the present invention provides a memory address remapping method for enhancing the page hit rate and bandwidth utilization so as to achieve the higher performance and decrease the latency in memory access.

It is the principal object of the present invention to provide a memory address remapping method. In order to reduce the percentage of long latency in memory access condition—(Bank-hit and Page-miss condition and memory access time), the memory address remapping method is performed by utilizing a linear operator, such as a XOR operator, for performing a linear calculation with two inputs, which are picked from a cache-related address respectively, in order to obtain a linear output, which is assigned to be a target location address of a target memory address, which indicates the target location that data is saved and distributed from cache to Moreover, the memory address remapping method of the present invention further comprises performing a replacing step, which is choosing several key transition bits from the tag of the cache-related address to replace several stable bits in the linear output, in order to further enhance the page hit rate and bandwidth utilization in memory access.

In accordance with the aforementioned purpose of the present invention, the present invention provides a memory address remapping method, and more particularly relates to a memory address remapping method utilized in various memory systems, such as DDR memory system and Rambus memory system (RDRAM system), for enhancing the efficiency of memory access. The memory address remapping method comprises: providing a cache-related address having a tag, an associative tag, a set index and a block offset; providing a linear operator; performing a linear calculation with a first linear operator input and a second linear operator input to obtain a first output, wherein the first linear operator input is several bits picked from the set index of the cache-related address according to a quantity and a corresponding location of a plurality of bits in the location address of a memory address, such as DDR memory-related address, Rambus memory-related address, etc., and the second linear operator input is several bits picked from the tag and the associative tag of the cache-related address according to the quantity of the plurality of bits in the location address; and performing a replacing step comprising: choosing several key transition bits from the tag to replace several first-output bits in the first output for obtaining a second output, wherein the several first-output bits in the first output are more stable than other first-output bits in the first output, and the several key transition bits have a characteristic of more frequent changing than other bits that are higher order than the several key transition bits in the tag; and assigning the second output to be a target location address of a target memory address of a plurality of memory addresses, wherein data is saved from the cache to the target location in correspondence with the target memory address.

Moreover, if the present invention is utilized in a DDR memory system, the plurality of memory addresses are a plurality of DDR memory-related addresses, and the location address of a DDR memory-related address consists of a DIMM address, a side address and a bank index, and the target location address of a target DDR memory-related address consists of a target DIMM address, a target side address and a target bank index. If the present invention is utilized in a Rambus memory system, and the plurality of memory addresses are a plurality of Rambus memory-related addresses, and the location address of a Rambus memory-related address consists of a bank address and a device address, and the target location address of a target Rambus memory-related address consists of a target bank address and a target device address. In addition, the linear operator could be an exclusive-or operator, and the linear calculation is an exclusive-or calculation thereby.

Furthermore, if the present invention is utilized in a Rambus memory system, the memory address remapping method of the present invention further comprising performing a replacing step, which is choosing a replacing bit from the tag to replace a stable bit in a target bank address of the target location address of the target memory address for obtaining an output, wherein the replacing bit has a characteristic of more frequent stable than other bits that are higher order than the replacing bit in the tag, and the data is saved from the cache to the target location in correspondence with the output.

Therefore, the goal of distributing pages into different memory banks is achieved. Moreover, not only memory page hit rate is increased by normally distributing pages into different memory banks, but also the localization of each memory address is reserved longer than that by the existing method.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a diagram showing the memory accesses with Bank-miss and Page-miss;

FIG. 2 is a timing relationship between the current memory access and subsequent memory access with Bank-miss and Page-miss according to FIG. 1;

FIG. 3 is a diagram showing the memory accesses with Bank-hit and Page-miss;

FIG. 4 is a timing relationship between the current memory access and subsequent memory access with Bank-hit and Page-miss according to FIG. 3;

FIG. 5 is a diagram showing the definition of a conventional cache-related address in a cache;

FIG. 6 is a diagram showing the definition of a conventional DDR memory-related address in a DDR memory module;

FIG. 7 is a diagram showing the definition of a conventional Rambus memory-related address;

FIG. 8 is a diagram showing the relationship between the conventional cache-related address and the conventional DDR memory-related address according to FIG. 5 and FIG. 6;

FIG. 9 is a diagram showing the relationship between the conventional cache-related address and the conventional Rambus memory-related address according to FIG. 5 and FIG. 7;

FIG. 10 is a diagram showing a preferred embodiment of the memory address remapping method for a DDR memory system according to the present invention;

FIG. 11 is a table showing the results of input and each output in performing the preferred embodiment of the memory address remapping method to the DDR memory system according to FIG. 10;

FIG. 12 is a diagram showing another preferred embodiment of the memory address remapping method for DDR memory system according to the present invention;

FIG. 13 is a table showing the results of input and output in performing the preferred embodiment of the memory address remapping method for the DDR memory system according to FIG. 12; and

FIG. 14 is a diagram showing a preferred embodiment of the memory address remapping method for a Rambus memory system according to the present invention.

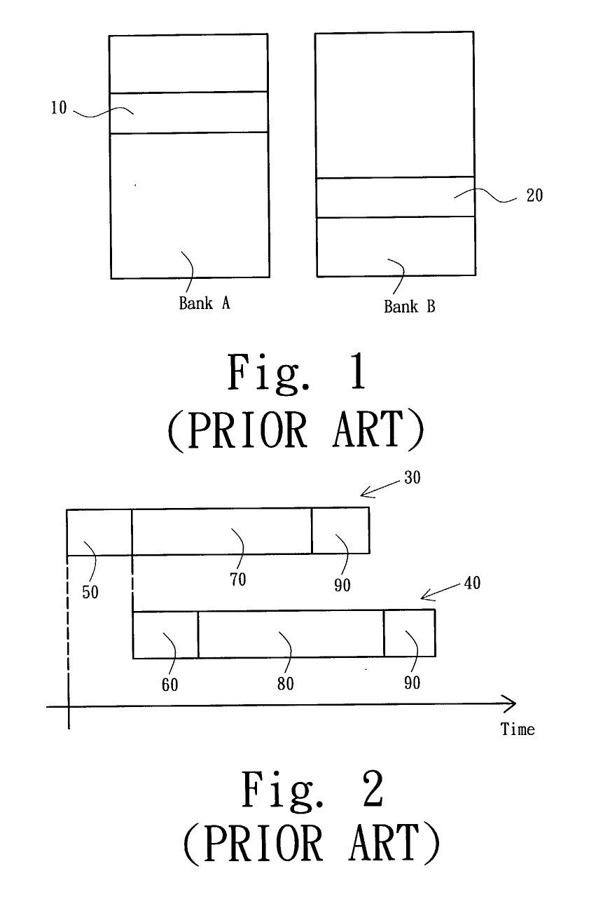

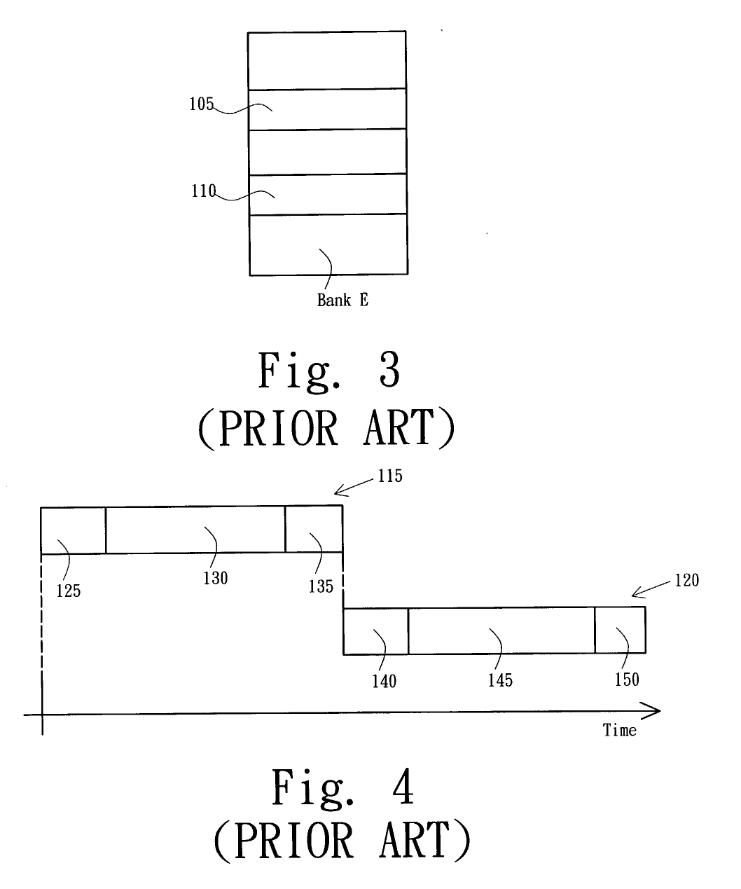

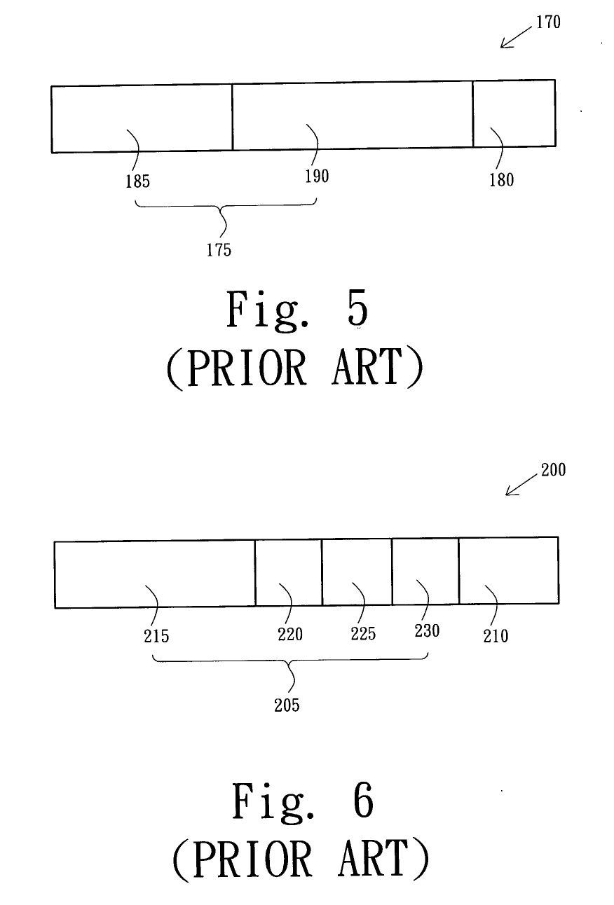

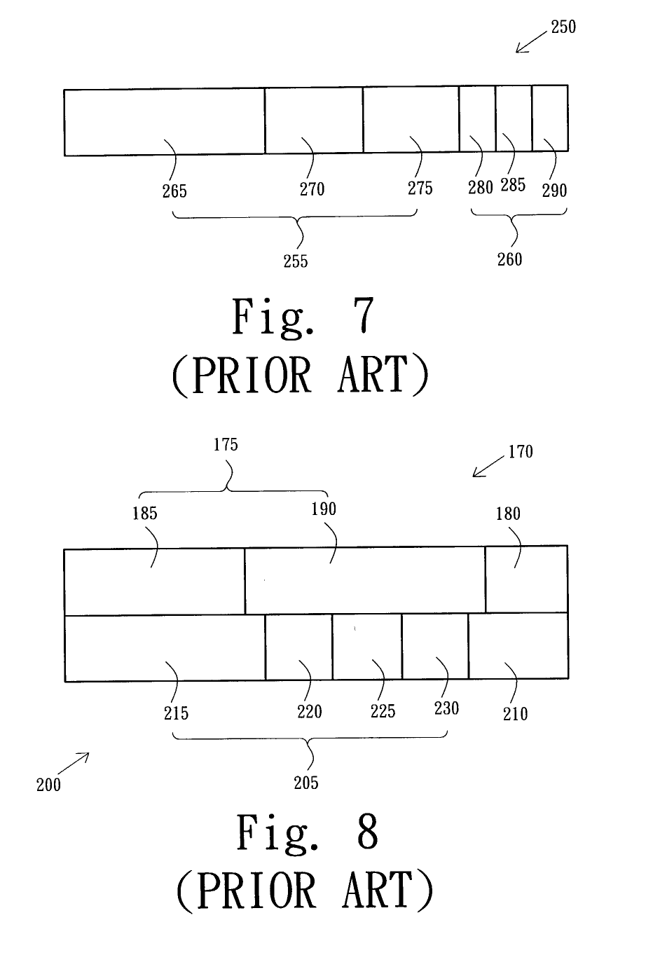

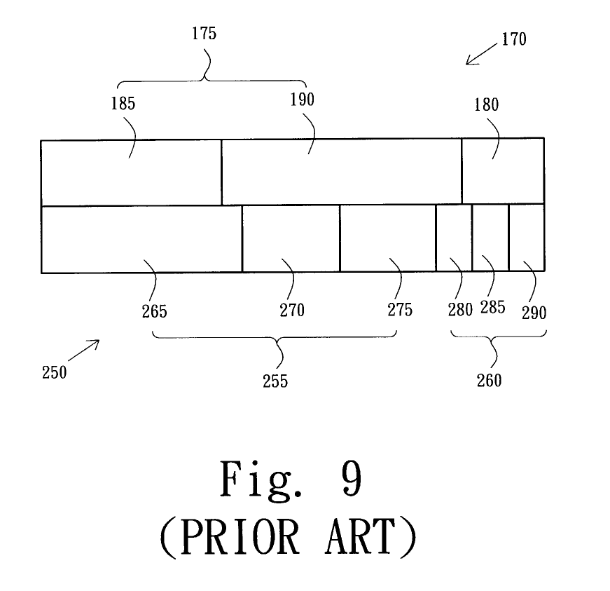

### DETAILED DESCRIPTION OF THE PREFERRED EMBODIMENT

In order to improve the efficiency of memory access, the memory address remapping method is provided by the present invention, wherein there are several cases of memory access, such as:

Case 1.—Data transaction crossing memory bus coupling the north bridge to memory module; and

Case 2.—Data transaction of computer system having at least one CPU, wherein the at least one CPU is connected with at least one main memory bus coupling at least one main memory module.

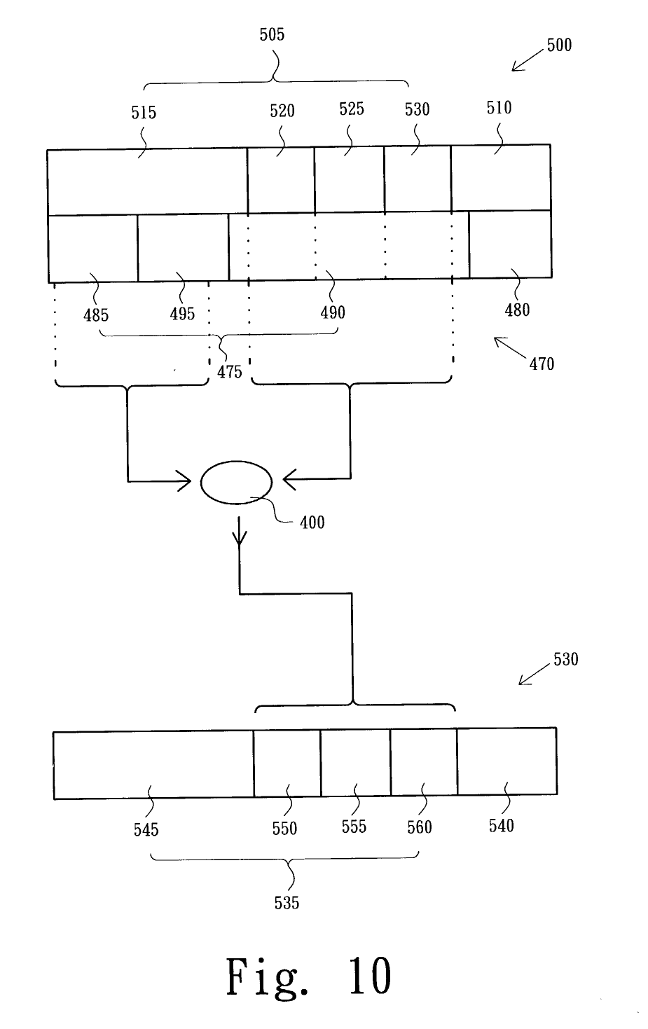

Moreover, in the memory address remapping method of the present invention, the traditional tag of a cache-related address is partitioned to be a tag 485 and an associative tag 495 (shown in FIG. 10).

As long as the bits of tag (hereinafter the tag bits) and bits of associative tag (hereinafter the associative tag bits) of any cache-related address are different from those of the other cache-related addresses, the memory address remapping method of the present invention can be utilized and implemented efficiently on various memory systems having different operations and architectures, such as SDRAM system, DDR memory system, Rambus memory system, etc.

Since there are many various definitions and expressions about memory addresses in various memory systems, for briefly explaining the theorem of the present invention utilized in various memory systems, the plurality of bits, which indicate the location in memory module to which data is located and stored, is referred as a “location address” hereinafter. For example, if the present invention is implemented in a DDR memory system, the DIMM address, the side address and the bank index of a DDR memory-related address are referred as a “location address” since the DDR memory system, the DIMM address, the side address indicate the location in DDR memory module to which data is located and stored. For another example, if the present invention is implemented in a Rambus memory system, similarly, the bank address and the device address are referred as a “location address” since the bank address and the device address indicate the location in Rambus memory module to which data is located and stored.

When data is saved and distributed from cache to a target location in a memory module, by utilizing the memory address remapping method of the present invention, a linear operator, such as an exclusive-or operator (hereinafter XOR operator), an addition operator, a subtraction operator, and etc., is utilized to perform a linear calculation with two inputs for obtaining a linear output, wherein one of the two inputs is a plurality of bits picked from the set index of a cache-related address, to which the data corresponds, according to the quantity and the location of bits in the location address of a memory address, and another one of the two inputs is a plurality of bits picked from the tag and the associative tag of the cache-related address according to the quantity of bits in the location address of the memory address. After the linear calculation has been performed, the linear output is obtained and assigned to be the plurality of bits in the target location address of a target memory address, which indicates the target location in the memory module.

For example, please referring to FIG. 10, FIG. 10 is a diagram showing a preferred embodiment of the memory address remapping method for a DDR memory system according to the present invention. As shown in FIG. 10, a cache-related address 470 is provided, and one DDR memory-related address 500 of a plurality of DDR memory-related addresses is presented, respectively, wherein the data of cache-related address 470 is going to distributed to a target DDR memory-related address 530, which is one of the plurality of DDR memory-related addresses, and the block offset 480 is recorded for other related data about the cache-related address 300, the page offset 510 and the high page index 515 are recorded for other related data about the DDR memory-related address 500 as well.

By utilizing the memory address remapping method of the present invention in a DDR memory system, an XOR operator 400 is utilized to perform an XOR calculation for obtaining a linear output. First, if the quantity of total bits of the DIMM address 520, side address 525 and bank index 530 in the DDR memory-related address 500 is three, several bits, such as three bits “1,1,0”, in the set index 490 of the cache-related address 470 are selected to be an input of the XOR operator 400 in correspondence to the locations of total bits of the DIMM address 520, side address 525 and bank index 530.

Then, since the quantity of total bits of the DIMM address 520, side address 525 and bank index 530 in the DDR memory-related address 500 is three, several bits, such as three bits “1,1,1” in tag 485 and associative tag 495 of the cache-related address 470 are selected from the lowest order of associative tag 495 to be another input of the XOR operator 400 in correspondence to the locations of total bits of the DIMM address 520, side address 525 and bank index 530.

After the XOR calculation with the “1,1,0” and “1,1,1” is performed, the linear output of XOR operator 400 is obtained based on logical calculation theorem, wherein the linear output—“0,0,1” is assigned in correspondence to the target DIMM address 550, target side address 555 and target bank index 560 of the target DDR memory-related address 530 that is for data to be saved from cache to the DDR memory module, and the page offset 540 and the high page index 545 of the target DDR memory-related address 530 are recorded for other related data about the target DDR memory-related address 530 as well.

In other words, if the memory address remapping method of the present invention is implemented in the DDR memory system, several bits of the set index 490 of the cache-related address 470 are selected to be an XOR operator input according to the bit's locations and the quantity of total bits of the DIMM address 520, side address 525 and bank index 530 of the DDR memory-related address 500, and several bits of tag 485 and associative tag 495 of the cache-related address 470 are selected to be another XOR operator input according to the quantity of total bits of the DIMM address 520, side address 525 and bank index 530 of the DDR memory-related address 500. After the XOR calculation has been performed, the linear output is obtained and assigned to be the plurality of bits in a target location address, which composes of the target DIMM address 550, target side address 555 and target bank index 560.

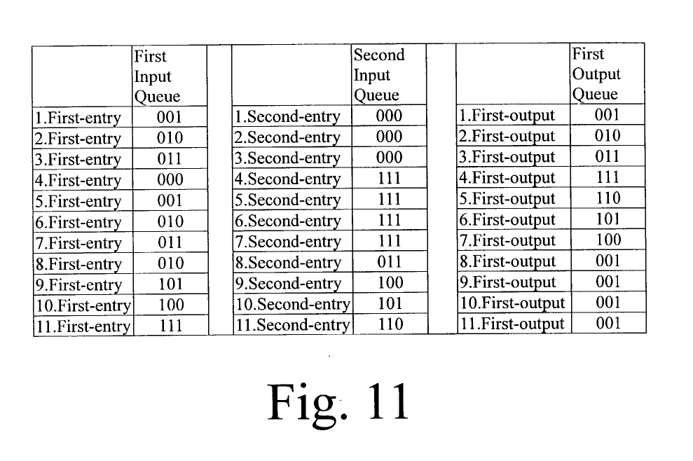

Please referring to FIG. 11, FIG. 11 is a table showing the results of input and each output in performing the preferred embodiment of the memory address remapping method to the DDR memory system according to FIG. 10. As shown in FIG. 11, the two inputs of XOR operator 400 are a first input queue having eleven first-entries and a second input queue having eleven second-entries, wherein according to the aforementioned description about picking the two inputs of the XOR operator, any one of eleven first-entries is selected from the tag 485 and associative tag 495, and is composed of three bits, and any one of eleven second-entries is selected from the set index 490, and is composed of three bits also if there are three bits among the DIMM address 520, side address 525 and bank index 530 in the DDR memory-related address 500.

In each XOR calculation, one first-entry and one second-entry are inputted to the XOR operator 400 respectively, and then one first-output of XOR operator 400 is obtained, and each first-output forms a first output queue in sequence after the eleven first-entry and eleven second-entry are calculated. For example, in the first-entry “1,1,1” and the second-entry “1,1,0” are inputted to the XOR operator 400 respectively, and then “0,0,1” is obtained. Obviously, most of first-outputs are different from each other, so that data of each cache-related address can be distributed to page in different bank of DDR memory module because each bank index of DDR memory-related address is different to the one of other DDR memory-related address after the XOR calculation and assigning into corresponding target DIMM address, corresponding target side address and corresponding target bank index as description above. In addition, the localization of memory references is preserved because all addresses in the same page are still in the same page after the linear calculation.

However, there may be several first-outputs having the same bits, such as “0,0,1”, in the first output queue after the XOR calculation. In order to obtain more first-outputs having different bits, a preferred embodiment of the memory address remapping method of the present invention is provided.

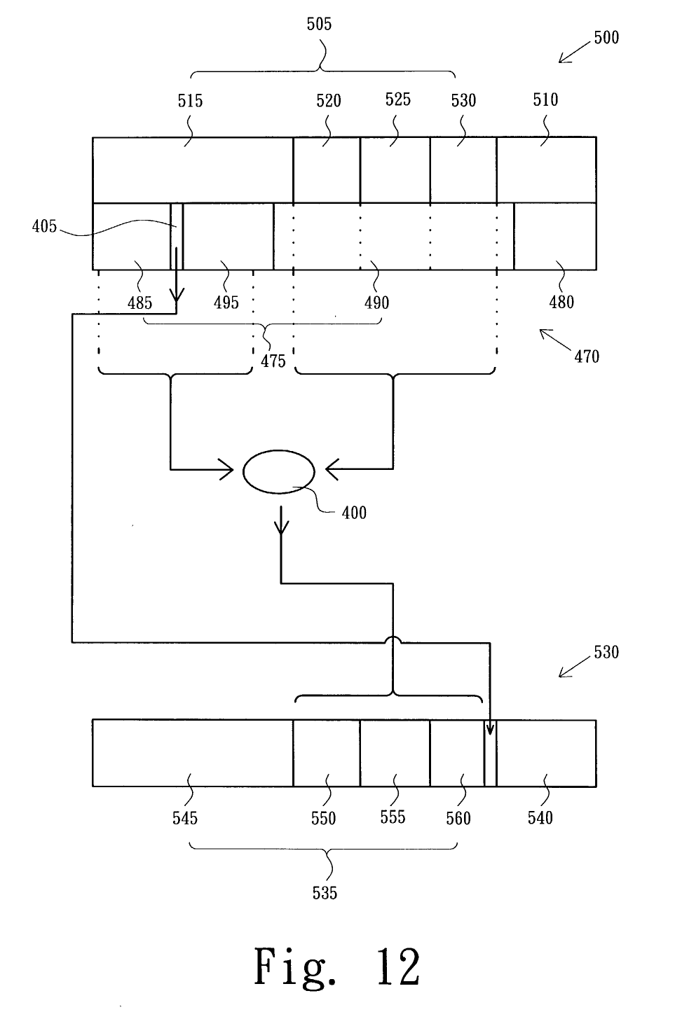

Please referring to FIG. 12, FIG. 12 is a diagram showing another preferred embodiment of the memory address remapping method for DDR memory system according to the present invention. As shown in FIG. 12, the cache-related address 470 is provided and the DDR memory-related address 500 is presented. In order to obtain more outputs having different bits in the first output queue after the linear calculation of FIG. 10, the preferred embodiment of the memory address remapping method for the DDR memory system of FIG. 12 further provides a replacing step for each first-output generated by the linear calculation.

Since the bits in tag 485, the bits in associative tag 495 and the bits in set index 490 have the same transition behavior between the current and subsequent accesses in some frequent access patterns appeared in several case, such as benchmark operations, thus, several bits, which have the characteristic of frequent variableness among the bits of tag 485 during accessing in accordance with statistics and evaluation, are chosen from the tag 485 and are called “key transition bits” 405. Furthermore, it is more appropriate to choose these key transition bits 405 from the lower order bits of tag 485 because there is more probability that the lower order bits of tag 485 will change due to cache replacement property. By utilizing this key transition bits 405 to replace the stable bits 415, which are the bits that are always stable in each output, more outputs having different bits in the output queue after the replacing step are obtain thereby. Therefore, after linear calculation, more target DDR memory-related addresses having different target DIMM addresses 550, target side address 555 and target bank indices 560 are obtained, and the goal of distributing the data of cache to pages of different banks is achieved.

For example, in FIG. 12, the linear calculation like the one of FIG. 10 is executed first, and then the table shown in FIG. 11 is obtained, wherein there are several same first-outputs—“0,0,1”, and according to the statistics, the lowest order bit of each output is the bit “1” usually, which means that the lowest order bit of each first-output is more stable than other bits of each first-output. In order to obtain different first-outputs with each other in the first output queue, key transition bits 405 can be chosen to replace this stable bit—“1”, according to the aforesaid description about choosing the key transition bits 410.

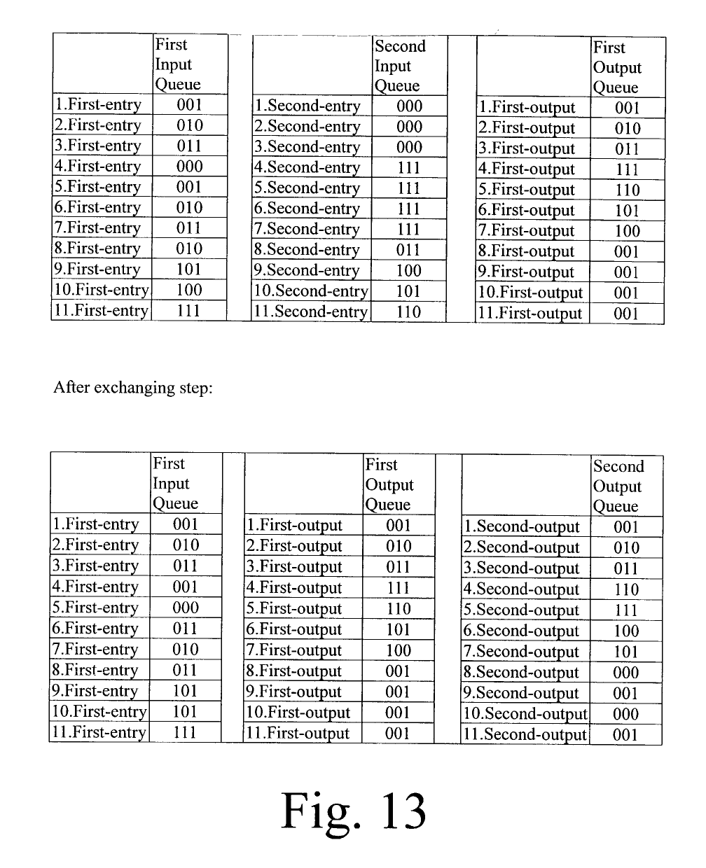

Please referring to FIG. 13, FIG. 13 is a table showing the results of input and output in performing the preferred embodiment of the memory address remapping method for the DDR memory system according to FIG. 12. As shown in FIG. 13, the two inputs of XOR operator are a first input queue having eleven first-entries and a second input queue having eleven second-entries, according to the aforementioned description about picking the two inputs of the XOR operator, any one of eleven first-entries is selected from the tag 485 and associative tag 495, and is composed of three bits, and any one of eleven second-entries is selected from the set index 490, and is composed of three bits also if there are three bits among the DIMM address 520, side address 525 and bank index 530 in the DDR memory-related address 500.

In order to obtain different outputs with each other in the output queue, the key transition bit 405 can be chosen from each first-entry of the first input queue to replace the stable bit of each first-output in the first output queue. Therefore, a plurality of second-outputs are obtained and form a second output queue, and obviously, each second-output is different from the subsequent second-output. The goal of distributing the data of cache to pages of different banks is achieved efficiently.

The memory address remapping method of the present invention is not only implemented in a DDR memory system, but also is implemented in other memory systems, such as a Rambus memory system.

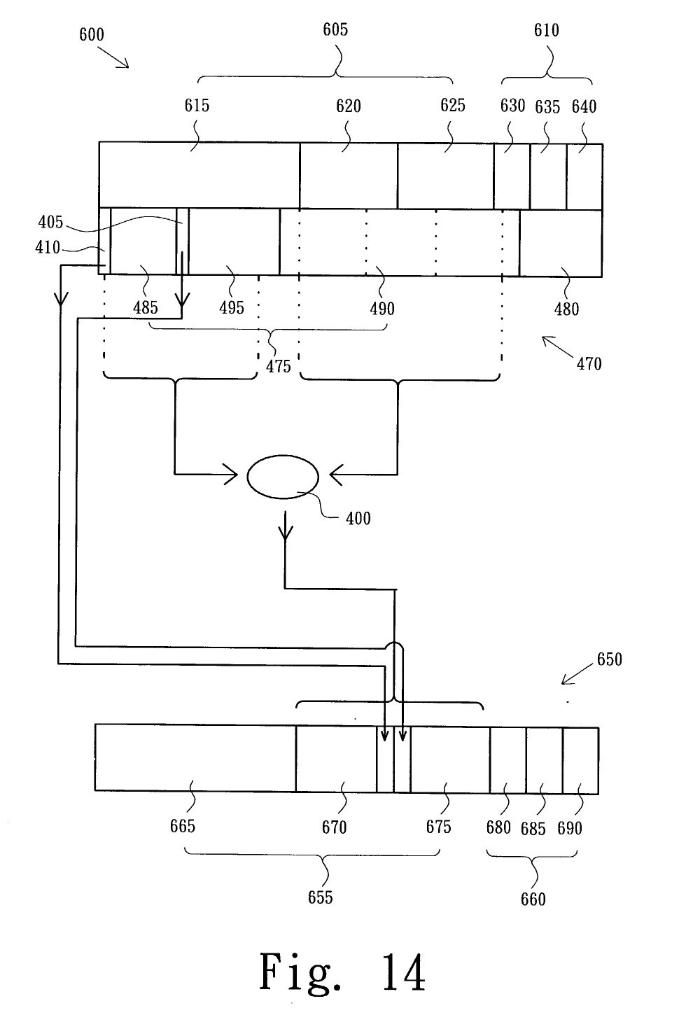

For example, please referring to FIG. 14, FIG. 14 is a diagram showing a preferred embodiment of the memory address remapping method for a Rambus memory system according to the present invention. As shown in FIG. 14, a cache-related address 470 is provided, and one Rambus memory-related address 600 of a plurality of Rambus memory-related addresses is presented, respectively, wherein the data of cache-related address 470 is going to distributed to a target Rambus memory-related address 650, which is one of the plurality of Rambus memory-related addresses, and the block offset 480 is recorded for other related data about the cache-related address 470, and the row address 615 of the page index 605 and the column 630, the channel 635 and the offset 640 of the page offset 610 are recorded for other related data about the Rambus memory-related address 600.

If the memory address remapping method of the present invention is implemented in the Rambus memory system, several bits of the set index 490 of the cache-related address 470 are selected to be an XOR operator input according to the bit's locations and the quantity of total bits of the bank address 620 and the device address 625 of the Rambus memory-related address 600, and several bits of tag 485 and associative tag 495 of the cache-related address 470 are selected to be another XOR operator input according to the quantity of total bits of the bank address 620 and the device address 625 of the Rambus memory-related address 600. After the XOR calculation has been performed, the linear output is obtained and assigned to be the plurality of bits in a target location address, which composes of the target bank address 670 and target device address 675.

In order to obtain more outputs having different bits from each other, a replacing step is performed by utilizing key transition bits 405, and the concerned operative theorem of the present invention in Rambus memory system is similar to the one of the present invention in DDR memory system. Furthermore, the replacing step is performed not only by utilizing the key transition bits 405, but also by utilizing an replacing bit 410 chosen from the tag 485 of cache-related address 470 to replace the lowest order bit of bank address 670, wherein the replacing bit 410 has a characteristic of more frequent stable than other bits that are lower order than the replacing bit 410 in the tag 485. Finally, the goal of distributing the data of cache to pages of different banks is achieved efficiently.

On the other hand, the present invention is not limited to the aforementioned implementations, and can also be implemented in various memory systems, so as to enhance the page hit and the bandwidth utilization.

The advantage of the present invention is to provide a memory address remapping method, and more particularly relates to a memory address remapping method utilized in various memory system, such as a DDR memory system, a Rambus memory system, etc., for enhancing the efficiency of memory access and reducing the access time from processor and devices to memory modules. Compared to the conventional design, the present invention supports an effective method to distribute data to pages of different banks, so that the page hit rate is increased and the delay of memory access is decreased.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A memory address remapping method, which is utilized in a memory system having a plurality of memory addresses when a data is saved from a cache to a target location in a memory module of the memory system, wherein each of the plurality of memory addresses has a location address, the memory address remapping method comprising:
providing a cache-related address, wherein the cache-related address comprises a tag, an associative tag, a set index and a block offset, and is corresponding to the data;
providing a linear operator;
performing a linear calculation with a first linear operator input and a second linear operator input to obtain a first output, wherein the first linear operator input is a plurality of first-input bits that are selected from the set index according to a quantity and a corresponding location of a plurality of bits in the location address of a memory address of the plurality of memory addresses, and meanwhile, according to the quantity of the plurality of bits in the location address, the second linear operator input is a plurality of second-input bits that are selected from the tag and the associative tag; and
assigning the first output to be a target location address of a target memory address of the plurality of memory addresses, wherein the data is saved from the cache to the target location in correspondence with the target memory address.

2. The memory address remapping method of claim 1, wherein a quantity of a plurality of first-output bits in the first output is equal to the quantity of the plurality of bits in the location address.

3. The memory address remapping method of claim 1, wherein the memory system is a DDR memory system, and the plurality of memory addresses are a plurality of DDR memory-related addresses, and the target memory address is a target DDR memory-related address as well, and the location address in each of the plurality of DDR memory-related addresses consists of a DIMM address, a side address and a bank index, and the target location address of the target DDR memory-related address consists of a target DIMM address, a target side address and a target bank index.

4. The memory address remapping method of claim 1, wherein the memory system is a Rambus memory system, and the plurality of memory addresses are a plurality of Rambus memory-related addresses, and the target memory address is a target Rambus memory-related address as well, and the location address in each of the plurality of Rambus memory-related addresses consists of a bank address and a device address, and the target location address of the target Rambus memory-related address consists of a target bank address and a target device address.

5. The memory address remapping method of claim 1, wherein the linear operator is an exclusive-or operator, and the linear calculation is an exclusive-or calculation.

6. A memory address remapping method, which is utilized in a memory system having a plurality of memory addresses when a data is saved from a cache to a target location in a memory module of the memory system, wherein each of the plurality of memory addresses has a location address, the memory address remapping method comprising:
providing a cache-related address, wherein the cache-related address comprises a tag, an associative tag, a set index and a block offset, and is corresponding to the data;
providing a linear operator;
performing a linear calculation with a first linear operator input and a second linear operator input to obtain a first output, wherein the first linear operator input is a plurality of first-input bits that are selected from the set index according to a quantity and a corresponding location of a plurality of bits in the location address of a memory address of the plurality of memory addresses, and meanwhile, according to the quantity of the plurality of bits in the location address, the second linear operator input is a plurality of second-input bits that are selected from the tag and the associative tag; and
performing a replacing step comprising:
choosing a plurality of key transition bits from the tag to replace parts of a plurality of first-output bits in the first output for obtaining a second output, wherein the parts of the plurality of first-output bits in the first output are more stable than other first-output bits in the first output, and the plurality of key transition bits are chosen from the tag according to a location of the several first-output bits of the plurality of first-output bits in the first output, and furthermore, the plurality of key transition bits have a characteristic of more frequent changing than other bits that are higher order than the plurality of key transition bits in the tag; and
assigning the second output to be a target location address of a target memory address of the plurality of memory addresses, wherein the data is saved from the cache to the target location in correspondence with the target memory address.

7. The memory address remapping method of claim 6, wherein a quantity of a plurality of first-output bits in the first output is equal to the quantity of the plurality of bits in the location address.

8. The memory address remapping method of claim 6, wherein the memory system is a DDR memory system, and the plurality of memory addresses are a plurality of DDR memory-related addresses, and the target memory address is a target DDR memory-related address as well, and the location address in each of the plurality of DDR memory-related addresses consists of a DIMM address, a side address and a bank index, and the target location address of the target DDR memory-related address consists of a target DIMM address, a target side address and a target bank index.

9. The memory address remapping method of claim 6, wherein the memory system is a Rambus memory system, and the plurality of memory addresses are a plurality of Rambus memory-related addresses, and the target memory address is a target Rambus memory-related address as well, and the location address in each of the plurality of Rambus memory-related addresses consists of a bank address and a device address, and the target location address of the target Rambus memory-related address consists of a target bank address and a target device address.

10. The memory address remapping method of claim 6, wherein the linear operator is an exclusive-or operator, and the linear calculation is an exclusive-or calculation.

11. A memory address remapping method, which is utilized in a Rambus memory system having a plurality of memory addresses when a data is saved from a cache to a target location in a module module of the Rambus memory system, wherein each of the plurality of memory addresses has a location address consisting of a bank address and a device address, the memory address remapping method comprising:
providing a cache-related address, wherein the cache-related address comprises a tag, an associative tag, a set index and a block offset, and is corresponding to the data;
providing a linear operator;
performing a linear calculation with a first linear operator input and a second linear operator input to obtain a first output, wherein the first linear operator input is a plurality of first-input bits that are selected from the set index according to a quantity and a corresponding location of a plurality of bits in the location address of a memory address of the plurality of memory addresses, and meanwhile, according to the quantity of the plurality of bits in the location address, the second linear operator input is a plurality of second-input bits that are selected from the tag and the associative tag; and
performing a replacing step comprising:
choosing a plurality of key transition bits from the tag to replace parts of a plurality of first-output bits in the first output for obtaining a second output, wherein the parts of the plurality of first-output bits in the first output are more stable than other first-output bits in the first output, and the plurality of key transition bits are chosen from the tag according to a location of the several first-output bits of the plurality of first-output bits in the first output, and furthermore, the plurality of key transition bits have a characteristic of more frequent changing than other bits that are higher order than the plurality of key transition bits in the tag;
assigning the second output to be a target location address of a target memory address of the plurality of memory addresses; and
choosing a replacing bit from the tag to replace a stable bit in a target bank address of the target location address of the target memory address for obtaining an output, wherein the replacing bit has a characteristic of more frequent stable than other bits that are higher order than the replacing bit in the tag, and the data is saved from the cache to the target location in correspondence with the output.

12. The memory address remapping method of claim 11, wherein a quantity of a plurality of first-output bits in the first output is equal to the quantity of the plurality of bits in the location address.

13. The memory address remapping method of claim 11, wherein the linear operator is an exclusive-or operator, and the linear calculation is an exclusive-or calculation.

14. The memory address remapping method of claim 11, wherein the plurality of memory addresses are a plurality of Rambus memory-related addresses, and the target memory address is a target Rambus memory-related address as well, and the location address in each of the plurality of Rambus memory-related addresses consists of a bank address and a device address, and the target location address of the target Rambus memory-related address consists of the target bank address and a target device address.
